(19) United States
(12) Patent Application Publication
(10) Pub. No.: US 2025/0305405 A1
(43) Pub. Date: Oct. 2, 2025

(54) BORE MAPPING DEVICE, SYSTEM FOR MAPPING WELLBORES AND METHODS OF USE

(71) Applicant: SAUDI ARABIAN OIL COMPANY, Dhahran (SA)

(72) Inventors: Ali Abdullah BAKRY, Khurais (SA); Qasim A. ALKHALIFA, Udhailiyah (SA); Hashem A. ALGHAFLI, Udhailiyah (SA)

(73) Assignee: SAUDI ARABIAN OIL COMPANY, Dhahran (SA)

(21) Appl. No.: 18/617,029

(22) Filed: Mar. 26, 2024

(51) Int. Cl. E21B 47/002; E21B 47/09

(52) U.S. Cl. CPC E21B 47/0025; E21B 47/09; E21B 2200/20

(57) ABSTRACT

A well system includes a surface installation provided at a well surface location, a wellbore extending from the surface installation and providing an open hole section, a bore mapping device conveyable into the wellbore on a conveyance and including a bore surface mapping sensor operable to sense a surface of the open hole section as the bore mapping device traverses the wellbore, and an obstruction sensor arranged at a downhole end of the bore mapping device and operable to sense obstructions within the wellbore. A data acquisition system is in communication with the bore mapping device to receive data generated by the bore surface mapping sensor and the obstruction sensor and is operable to create a three-dimensional model of the open hole section of the wellbore.

### FIELD OF THE DISCLOSURE

This invention relates to a bore mapping device, a system for mapping wellbores and a method of using a bore mapping device. In particular, this invention relates to a bore mapping device or smart laser caliper tool for measuring, logging and mapping the geometry of a wellbore used for extracting hydrocarbons.

### BACKGROUND OF THE DISCLOSURE

Mapping of a wellbore after drilling serves to facilitate a smoother installation of casing (or liner) for stabilizing the wellbore and preventing leakage of oil or gas during the extraction process. The casing (or liner) is crucial for ensuring optimal extraction and minimizing environmental impact during oil or gas extraction. Wellbores, such as open hole sections extending downhole from the casing (or liner), are traditionally measured and mapped using mechanical calipers and/or laser loggers to obtain bore surface measurements. Such devices, however, having certain limitations as will become apparent below.

For example, mechanical calipers use spring-loaded, collapsible arms that expand and retract to measure the diameter of the wellbore at various intervals along the bore. However, debris accumulation on the caliper arms and obstructions in the bore may inhibit passage of the caliper through the bore. On the other hand, as laser loggers are unable to detect obstructions in the wellbore, they are susceptible to being damaged when travelling beyond a certain speed in the bore.

European Patent No. EP2955323 discloses an optical well-logging device that utilizes a diamond window assembly. This assembly is designed to be compressed against the wall of the wellbore, facilitating the acquisition of precise well characteristics measurements. The device operates by emitting optical radiation through the diamond window, with the reflected light being detected via the same assembly. Collected data is then transmitted to surface-based data acquisition and processing systems for storage and analysis. However, a critical aspect of this disclosure is that the device requires physical contact with sides of the wellbore.

U.S. Pat. No. 9,217,324 discloses a method for capturing topographic and contour information of formations in a bore. This is achieved using a caliper equipped with a single laser or acoustic source and a detector. The caliper is deployed into the wellbore, where a beam is emitted and detected after reflecting off the bore walls. The resulting data is transmitted to the surface for processing. As mentioned above, this device is unable to detect obstructions within the wellbore and is susceptible being damaged beyond a certain speed in the wellbore.

What is needed, therefore, is a bore mapping device or smart laser caliper tool that overcomes the perceived failings of conventional bore mapping devices and mechanical caliper tools.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a well system is disclosed and includes a surface installation provided at a well surface location, a wellbore extending from the surface installation and providing an open hole section, a bore mapping device conveyable into the wellbore on a conveyance and including a bore surface mapping sensor operable to sense a surface of the open hole section as the bore mapping device traverses the wellbore, and an obstruction sensor arranged at a downhole end of the bore mapping device and operable to sense obstructions within the wellbore. A data acquisition system is in communication with the bore mapping device to receive data generated by the bore surface mapping sensor and the obstruction sensor and operable to create a three-dimensional model of the open hole section of the wellbore.

According to another embodiment consistent with the present disclosure, a method for mapping a wellbore is disclosed and includes the steps of conveying a bore mapping device into a wellbore extending from a surface installation, the wellbore providing an open hole section, sensing a surface of the open hole section with a bore surface mapping sensor of the bore mapping device as the bore mapping device traverses the wellbore, and thereby generating mapping data corresponding to the surface of the open hole section, sensing obstructions within the wellbore with an obstruction sensor arranged at a downhole end of the bore mapping device as the bore mapping device traverses the wellbore, transmitting the mapping data to a data acquisition system in communication with the bore mapping device; and processing the mapping data with the data acquisition system and thereby creating a three-dimensional model of the open hole section of the wellbore.

According to another embodiment consistent with the present disclosure, a bore mapping device is disclosed and includes a bore surface mapping sensor operable to sense a surface of an open hole section of a wellbore as the bore mapping device traverses the wellbore, an obstruction sensor arranged downhole from the bore surface mapping sensor to sense obstructions within the wellbore, and a data acquisition system in communication with the bore mapping device to receive data generated by the bore surface mapping sensor and the obstruction sensor and operable to create a three-dimensional model of the open hole section of the wellbore.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of an example well system that may employ the principles of the present disclosure, according to one or more embodiments.

FIG. 2 is a schematic flowchart of an example method of mapping a wellbore, according to one or more embodiment disclosed herein.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a bore mapping device. In particular, this invention relates to a bore mapping device or smart laser caliper tool for measuring, logging and mapping geometry of a bore for extracting oil or gas. Compared to conventional mechanical calipers used to measure wellbore geometry, the bore mapping devices described herein employ laser technology. Consequently, the bore mapping devices of the present disclosure can provide higher accuracy and real-time data acquisition, as compared to mechanical calipers. Moreover, the presently described bore mapping devices include a laser range finder, which can help reduce the risk of the tool getting stuck in the hole and lead to significant operational improvements and cost savings.

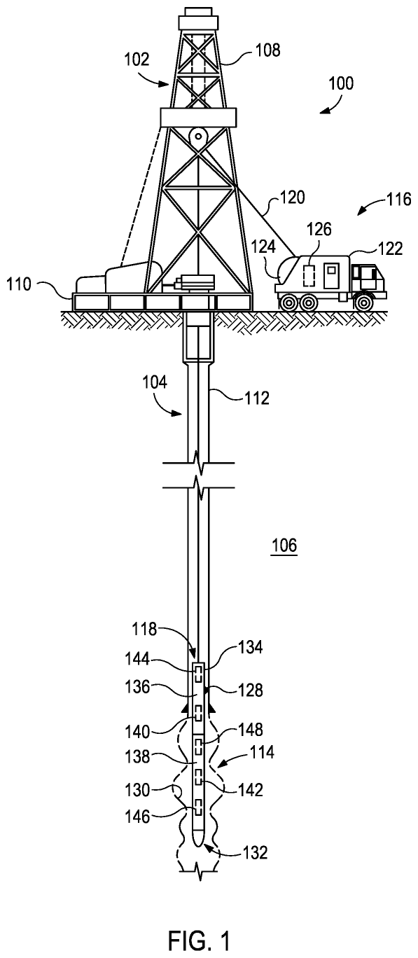

FIG. 1 is a schematic diagram of an example well system 100 that may employ the principles of the present disclosure, according to one or more embodiments. As illustrated, the well system 100 includes a surface installation 102 positioned at the Earth's surface (e.g., a “well surface location”) and a wellbore 104 extends from the surface installation 102 and penetrates one or more subterranean formations 106. In some embodiments, as illustrated, the surface installation 102 may comprise a service rig that includes a derrick 108 supported by a surface-mounted platform 110. In other embodiments, however, the surface installation 102 may comprise a wellhead or the like. Moreover, while the well system 100 is depicted as a land-based operation, it will be appreciated that the principles of the present disclosure could equally be applied in any offshore, sea-based, or sub-sea application where the surface installation 102 may be implemented with a floating platform, a semi-submersible platform, or a sub-surface wellhead installation, as generally known in the art.

A portion of the wellbore 104 may be lined with a string of casing 112, which may be secured in place within the wellbore 104 using cement. A lower portion of the wellbore 104, however, may not be lined with the casing 112, but may instead comprise a section of “open hole,” referred to herein as an open hole section 114 of the wellbore 104. As illustrated, the inner walls of the open hole section 114 may be undulating and otherwise exhibit a non-uniform geometry.

The well system 100 may further include a wireline system 116 operable to map any and all portions of the wellbore 104, such the open hole section 114 of the wellbore 104 below the casing 112, the interior (inner) surfaces of the casing 116, an inner surface of production tubing extended within the casing 112, or other tubulars or liners extended into the wellbore 104. As illustrated, the wireline system 116 includes a bore mapping device 118 conveyable into the wellbore 104 on a conveyance 120. The conveyance 120 may include, but is not limited to, wireline, electric line (or “E-line”), slickline, wired slickline, coiled tubing, wired coiled tubing, drill pipe, wired drill pipe, or any combination thereof. In some embodiments, as illustrated, the conveyance 120 may be dispensed from a surface-mounted wireline unit 122 (e.g., a truck or the like) having a drum 124 on which the conveyance 120 may be wound and unwound.

The bore mapping device 118 may be operatively and, in some embodiments, communicably coupled to the conveyance 120, thus enabling communication with the wireline unit 122 and, more particularly, a data acquisition system 126 forming part of the wireline unit 122. As described in more detail below, the data acquisition system 126 may be configured to receive mapping data generated by the bore mapping device 118 and process the mapping data in order to map portions of the wellbore 104.

In some embodiments, the wireline system 116 may be replaced with a drilling system or the like. In such embodiments, the bore mapping device 118 may form part of a bottom-hole assembly (BHA) extendable into the wellbore 104 from the surface installation 102 to drill and advance the depth of the wellbore 104. Moreover, in such embodiments, the conveyance 120 may comprise a string of drill pipe (or wired drill pipe) extended from the surface installation 102, and the BHA may include a drill bit arranged at the end of the drill pipe. The bore mapping device 118 may form part of the BHA to map the wellbore 104 as it is drilled.

As illustrated, the bore mapping device 118 may include a bore surface mapping sensor 128 for sensing and allowing mapping of a surface 130 of the wellbore 104 (e.g., an inner surface of the open hole section 114) as it descends therethrough, and an obstruction sensor 132 arranged in co-operation with the bore surface mapping sensor 128 for sensing any obstruction (not shown) in a path thereof as it passes through the wellbore 104 (e.g., as it advanced downhole).

A housing 134 is provided to house the bore surface mapping sensor 128, the obstruction sensor 132, and various electrical components (not shown) associated with the bore surface mapping sensor 128 and the obstruction sensor 132 therein. The housing 134 is sized and/or shaped to be smaller than the wellbore 104 to enable substantially contactless sensing and mapping of the surface 130 of the wellbore 104 by the bore surface mapping sensor 128. In particular, the housing 134 may have a length ranging between about three feet and about 10 feet, and may exhibit a diameter slightly smaller than the internal diameter of the wellbore 104 and/or the conduits (e.g., casing, liner, production tubing, etc.) arranged within the wellbore 104.

The housing 134 comprises a plurality of compartments for housing the bore surface mapping sensor 128, the obstruction sensor 132, and electrical components associated with the bore surface mapping sensor 128 and the obstruction sensor 132. Moreover, the housing 134 may be sealed for reducing a likelihood of ingress of substances (e.g., wellbore fluids) while in use, which could interfere with proper functioning of the bore surface mapping sensor 128 and/or the obstruction sensor 132. The housing 134 is constructed from a material which exhibits characteristics of the group comprising durability, corrosion resistance, temperature tolerance, and pressure resilience. The material for the housing 134 may be metallic, plastic, synthetic, or a combination thereof. In particular, the housing 134 may be constructed from any of the group comprising aluminum alloys, stainless steel, titanium, acrylonitrile butadiene styrene (ABS) plastic, polyether ether ketone (PEEK) thermoplastic polymer, a polymer alloy, nylon, carbon fiber composites, an epoxy resin, a composite material, a ceramic, or any combination thereof.

In some embodiments, the housing 134 may include vibration and/or shock absorbing members for protecting contents of the housing 134 from any mechanical stresses which may affect alignment of the bore surface mapping sensor 128 and the obstruction sensor 132. Example mechanical stresses include vibrations from moving components, impacts with surrounding environment, pressure changes, thermal expansion and contraction, or acoustic stress. The vibration and/or shock absorbing members are integrated into mounts (not shown), which secure the bore surface mapping sensor 128 and the obstruction sensor 132 to the housing 134.

In some embodiments, a window (not shown) may be integrated into the housing 134 for allowing the bore surface mapping sensor 128 and/or the obstruction sensor 132 to visually detect surfaces inside the wellbore 104. The material of the window is selected according to the type of sensor used for the bore surface mapping sensor 128 and/or the obstruction sensor 132. The window may be made of a variety of materials including, but not limited to, fused silica, sapphire, borosilicate glass, polycarbonate, PTFE (Polytetrafluoroethylene), LDPE (Low-Density Polyethylene), Rexolite (a cross-linked polystyrene), neoprene rubber, zinc selenide, specialized ceramic, and a metallic mesh. Preferably, the window is manufactured from a material suitable for the operation of optical sensors, the material being in the form of any of the group comprising fused silica, sapphire, borosilicate glass, and polycarbonate. In some embodiments, two or more windows may be integrated into the housing 134 and associated with the bore surface mapping sensor 128 and the obstruction sensor 132, respectively. The windows comprise surface modifications for reducing a likelihood of fog formation, scratching, and fluid accumulation. The surface modifications may include coatings, films or surface treatments. The coatings may comprise any of the group comprising hydrophilic coatings, hydrophobic coatings, and nanotechnology-based coatings. The films may comprise an anti-fog film.

In some embodiments, a thermal management arrangement may be provided for dissipating heat generated by the bore surface mapping sensor 128, the obstruction sensor 132 and associated electronics. The thermal management arrangement may be mounted within the housing 134 in the vicinity of the bore surface mapping sensor 128, the obstruction sensor 132 and associated electronics. The thermal management arrangement may comprise any one or more of the group comprising a heat sink, thermal pad, and a cooling system.

The bore surface mapping sensor 128 may comprise any sensor of the group comprising a light detection and ranging (LiDAR) sensor, an ultrasonic sensor, a radar (Radio Detection and Ranging) sensor, an infrared sensor, a structured light sensor, a dye laser, an excimer laser, a gas laser, or any combination thereof. A structured light sensor operates by projecting a predefined pattern of light, such as lines, grids or dots, onto a three-dimensional surface, capturing the distorted pattern with a camera, analyzing the deformation of the distorted pattern compared to the predefined pattern and calculating the shapes and depths of the surface using triangulation techniques. Preferably, the bore surface mapping sensor 128 comprises a LiDAR sensor, which operates by emitting pulsed laser light towards a target, measuring the time taken for the reflected light to return to the sensor, and utilizing this data to calculate distances to the target and generating precise three-dimensional representations of the target area (i.e., the wellbore 104).

In some embodiments, the bore surface mapping sensor 128 may include an emitter 136 for emitting light (i.e., electromagnetic radiation) towards the surface 130 of the wellbore 104, preferably towards surfaces defining inside walls of the wellbore 104 (e.g., the open hole section 114). The emitter 136 may be contained in a first compartment of the housing 134. The emitter 136 may comprise any laser of the group comprising a laser diode, a fiber laser, a solid-state laser, a microchip laser, a quantum cascade laser, a vertical-cavity laser, a surface-emitting laser, a supercontinuum laser, a semiconductor laser, or any combination thereof. Preferably, the emitter 136 comprises a laser diode, such as a semiconductor laser diode. The emitter 136 may be configured to emit light (i.e., electromagnetic radiation) in wavelengths associated with ultraviolet, visible, or infrared bands of the electromagnetic spectrum. The emitter 136 may also be configured to emit light of different wavelengths.

Alternatively, in some embodiments, a plurality of emitters 136 can be provided to emit light (i.e., electromagnetic radiation) at different wavelengths. It is to be appreciated that emitting light of various wavelengths provides enhanced object detection and discrimination, improved penetration in different conditions such as those in which fluids or dust are present, increased measurement accuracy, and improved error correction.

In some embodiments, the emitter 136 may be configured to emit light (i.e., electromagnetic radiation) having a wavelength associated with NIR (Near-Infrared) wavelengths, preferably having NIR wavelengths with increased penetration through fluids. The emitter 136 may have a beam divergence, which is dependent on a diameter of the wellbore 104. Preferably, the emitter 136 may have a beam divergence most suitable for bores with a diameter in the range of 0.1 m to 1 m. The beam divergence of the emitter 136 may be low so as to reduce a likelihood of excess scattering and/or reflection which would reduce measurement accuracy. For example, the beam divergence of the emitter 136 may be lower than 1 mrad (milliradians). It is to be appreciated that low beam divergence is associated with higher precision measurements, which may be crucial for accurately mapping geometry of the wellbore 104.

The emitter 136 may be configured to operate with a power output and/or pulse energy sufficient to ensure clarity of a return signal, which may be dependent on a diameter of the wellbore 104 and/or the presence of fluids in the wellbore 104. The power output may be in the range of about 1 mW to about 200 mW, and the pulse energy may be in the range of about 1 nJ to about 10 μJ. It is to be appreciated that a low to moderate power output in the range of about 1 mW to about 200 mW is believed to be most suitable for oil-laden wellbores. It is to be appreciated further that pulse energies in the range of about 1 nJ to about 10 μJ is believed to be most suitable for oil-laden wellbores, which have less reflective surfaces and which comprise fluids which may scatter emitted light.

The bore surface mapping sensor 128 may further include a detector 138 for detecting light (i.e., electromagnetic radiation) reflected off the surface 130 of the wellbore 104 after being emitted by the emitter 136. The detector 138 is selected according to design variables of the emitter 136 to ensure compatibility.

In some embodiments, the detector 138 may include a photodiode or photomultiplier tube. Preferably, the detector 138 includes one or more photodiodes. The photodiodes may be in the form of any of the group comprising a semiconductor photodiode, semiconductor photomultiplier, an avalanche photodiode, or any combination thereof. More particularly, the photodiodes may be in the form of a silicon photodiode or a silicon photomultiplier. Preferably, the detector 138 is in the form of a silicon photodiode.

In some embodiments, the detector 138 may provide or otherwise define a detection area dependent on one or more of light intensity, distance to the surface of the inner surface 130 of the wellbore 104, desired field of view, precision, speed, spatial resolution, power consumption, and environmental conditions. In particular, the detection area may be in the range of about 10 mm² to about 200 mm². The detector 138 may exhibit a relatively high detection sensitivity for ensuring measurements of sufficient accuracy. In particular, the detector 138 may exhibit a quantum efficiency greater than 70%, where quantum efficiency is a measure of how effectively a detector converts incoming light or photons into electrical current.

In at least one embodiment, the detector 138 may include an anti-reflective coating. Moreover, the detector 138 may be contained within a second compartment of the housing 134. The second compartment may define or provide a shielded enclosure for the detector 138.

The emitter 136 and the detector 138 may be cooperatively operate to enable the creation of a three-dimensional model or rendering of the wellbore 104. To accomplish this, the emitter 136 and the detector 138 may be arranged in any desired configuration including, but not limited to, coaxial, biaxial, monostatic, and multistatic. In a coaxial configuration, the emitter 136 and the detector 138 are aligned along the same axis such that optical components such as beam splitters, mirrors and lenses can be used to guide the generated beam (i.e., electromagnetic energy) as necessary. Advantages of the coaxial configuration include higher alignment accuracy and a simpler design. In a biaxial configuration, the emitter 136 and the detector 138 are spaced apart but point generally in the same direction. Advantages of the biaxial configuration include a larger field of view, ability to adjust the spacing between and/or orientation of the emitter 136 and detector 138 to optimize the sensor according to the required application, and improved resolution in short-range scanning applications. In a monostatic configuration, a single transceiver acts as both the emitter 136 and the detector 138. Advantages of the monostatic configuration include a compact design, simpler maintenance and calibration due to fewer components, and improved affordability. In a multistatic configuration, multiple emitters and detectors are utilized. Advantages of the multistatic configuration include increased versatility resulting from the numerous arrangements in which the emitters and detectors are positioned, enhanced coverage and/or detail, and the ability to adjust field of view and resolution to suit the requirements of the particular application. In at least one embodiment, the configuration of the emitter 136 and the detector 138 comprises a coaxial or monostatic configuration, which may offer high resolution data, precise measurements and a compact design-all of which are most suitable for use in an oil-laden wellbore.

In some embodiments, the bore surface mapping sensor 128 may further include a displacement mechanism 140 (shown as a dashed box) operable to displace (move, rotate, translate, etc.) the housing 134, the emitter 136 and/or the detector 138 for increasing an area over which measurements is captured. In such embodiments, for example, the displacement mechanism 140 may be configured to spin (rotate) the emitter 136 and/or detector 138 to enable 360-degree (or any angular magnitude) measurements of the wellbore 104 to be captured. In certain configurations in which multiple emitters and detectors are used, use of the displacement mechanism 140 may not be required if there are no gaps between the fields of view of each emitter and detector. The displacement mechanism 140 may include, but is not limited to, a stepper motor, a servo motor, a geared motor, a belt and pulley arrangement, an actuator arrangement, a gimbal mechanism, or any combination thereof.

In some embodiments, the bore surface mapping sensor 128 may further include a locating system 142 (shown as a dashed box) operable to determine a position and orientation of the emitter 136 and the detector 138 to facilitate the creation of three-dimensional models or renderings of the wellbore 104. The locating system 142 may include one or more rotary encoders for determining positions, orientations and speeds of spinning components. The locating system 142 may further include inertial measurement units for providing data on orientation, acceleration and gravitational forces acting on the sensor.

In some embodiments, the bore surface mapping sensor 128 may further include a control processor 144 (shown as a dashed box) operable to control operation of the bore surface mapping sensor 128, including the emitter 136 and the detector 138. In particular, the control processor 144 may be in communication with electronic components of the bore surface mapping sensor 128, such as the emitter 136, the detector 138, the displacement mechanism 140 (if included), and the locating system 142 (if included).

The obstruction sensor 132 may comprise a sensor selected from the group consisting of a light detection and ranging (LiDAR) sensor, an ultrasonic sensor, a radar (Radio Detection and Ranging) sensor, an infrared sensor, a laser range finder, a structured light sensor, or any combination thereof. Preferably, the obstruction sensor 132 comprises a laser range finder. As illustrated, the obstruction sensor 132 may be positioned at the lower or distal end of the housing 134 so as to enable a clear line of sight towards the downhole portions of the wellbore 104. In embodiments where the obstruction sensor 132 comprises a laser range finder, the obstruction sensor 132 may include a laser emitter configured to emit a laser having a suitable wavelength that accounts for various wellbore conditions including, but not limited to, pressure, temperature, presence of fluids, and reflective properties of the obstruction. The laser emitter may be configured to emit electromagnetic radiation (e.g., a laser) having a wavelength within a range between near-infrared to mid-infrared wavelength bands of the electromagnetic spectrum.

Example obstructions that may be detected by the obstruction sensor 132 include, but are not limited to, collar/joint components, cuttings, debris, scale deposits, mineral deposits, formation boundaries, or any combination thereof.

The laser emitter may comprise, but is not limited to, a laser diode, solid-state laser, a fiber laser or any combination thereof. Moreover, the laser range finder may include various optical elements, such as lenses for focusing a beam of the laser to improve measurement accuracy, particularly over larger distances. In at least one embodiment, the laser range finder may comprise a laser detector selected according to the choice of the laser emitter to ensure compatibility. The laser detector may include one or more photodiodes, such as an avalanche photodiode and a photomultiplier tube.

The obstruction sensor 132 may include a control unit operable to control operation of the obstruction sensor 132. More particularly, the control unit may be in communication with electronic components of the laser range finder, such as the laser emitter and the laser detector, and may further communicate with the control processor 144 to control operation of the obstruction sensor 132.

In some embodiments, the bore mapping device 118 may include an on-board power supply 146 for supplying power to the bore surface mapping sensor 128 and the obstruction sensor 132. The power supply 146 may comprise one or more batteries or fuel cells, for example. In other embodiments, however, the power supply 146 may be omitted and the bore mapping device 118 may instead be powered via the conveyance 120.

In some embodiments, the bore mapping device 118 may further include one or more sensors 148 operable to obtain measurements of various downhole conditions within the wellbore 104. The sensors 148 may include, for example, a temperature sensor operable to obtain temperature measurements from within the wellbore 104. Alternatively, or in addition thereto, the sensors 148 may include a pressure sensor operable to obtain pressure measurements in the wellbore 104.

The bore mapping device 118 may communicate with the data acquisition system 126 to provide real-time or delayed wellbore mapping data. In some embodiments, the bore mapping device 118 may wirelessly communicate with the data acquisition system 126 via any known wireless communication means. In other embodiments, however, the bore mapping device 118 may communicate with the data acquisition system 126 via wired communication facilitated by the conveyance 120.

The data acquisition system 126 is configured to receive mapping data generated by the bore surface mapping sensor 128, the obstruction sensor 132 and any other electronic components in the housing 134, and process the mapping data in order to map the surface 130 of the wellbore 104, preferably all inner surfaces of the wellbore 104. The data acquisition system 126 may be configured to obtain the mapping data generated by the bore surface mapping sensor 128 and the obstruction sensor 132 in real-time.

In some embodiments, the data acquisition system 126 may be configured to carry out a data filtering process for filtering noise from the mapping data, preferably filtering out outlying data points and accounting for any anomalies resulting from environmental conditions within the wellbore 104. The data acquisition system 126 may be configured to incorporate mapping data received from electronic components of the bore surface mapping sensor 128 and the obstruction sensor 132 in order to calibrate and correctly align the various data points in three-dimensional space. The data acquisition system 126 may be configured to construct a point cloud from the mapping data, where each data point represents a co-ordinate in three-dimensional space which coincides with locations where laser pulses were reflected to the sensors. The data acquisition system 126 may be configured to organize the point cloud data into a structured form which comprises sorting the data points into a grid or applying spatial indexing. The data acquisition system 126 may be configured to utilize various algorithms to interpret point cloud data to construct a three-dimensional model (not shown) of the surface 130 of the wellbore 104 in real-time. Construction of the three-dimensional model comprises connecting the points with a digital surface or mesh. The data acquisition system 126 may be configured to refine the three-dimensional model for improving the appearance of the digital surface. Refinement comprises surface smoothing and/or gap filling. The data acquisition system 126 may be configured to render and output the three-dimensional model (not shown) in a visual format for facilitating interpretation of the model by operators, geologists and/or engineers.

The data acquisition system 126 may be configured to analyze the data in order to accurately determine characteristics of the wellbore 104, such as shape, diameter, volume, and structural integrity. Other characteristics of the wellbore 104 that may be determined based on the obtained data include, but are not limited to, the location of cracks or fractures, varying lithology or permeability, casing (or tubing) corrosion, or any combination thereof. The data acquisition system 126 may be configured to produce the three-dimensional model and bore characteristics in real-time. Alternatively, or in addition thereto, the data acquisition system 126 may include a memory or data storage device for storing wellbore mapping data. The data can be raw data received from the sensors 148 or the data can be processed data relating to the three-dimensional model, which may be generated at a later time and otherwise on-demand. The data acquisition system 126 may include or be communicably coupled to a monitor, a graphical user interface (GUI), or a display capable of displaying the wellbore data and/or the three-dimensional model of the surface 130 of the wellbore 104 in real-time.

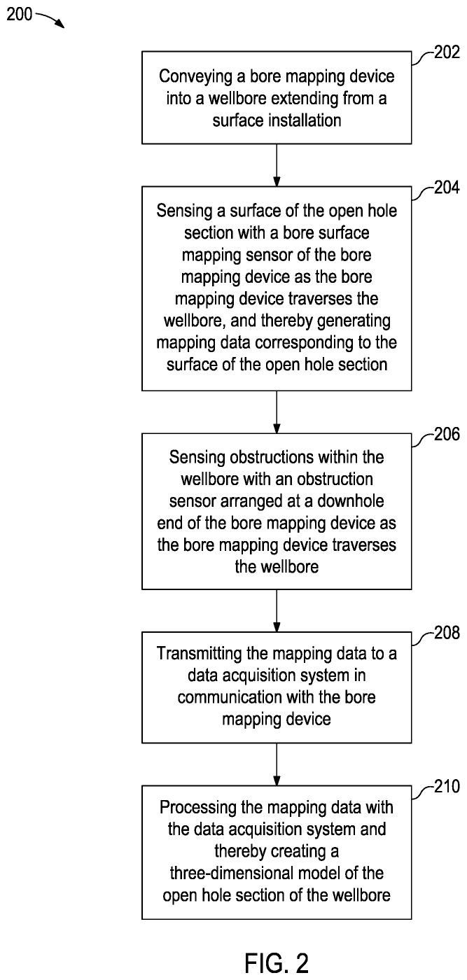

FIG. 2 is a schematic flowchart of an example method 200 of mapping a wellbore, according to one or more embodiment disclosed herein. As illustrated, the method 200 may include conveying a bore mapping device into a wellbore extending from a surface installation, as at 202. In some applications, the wellbore may provide an open hole section. The method 200 may further include sensing a surface of the open hole section with a bore surface mapping sensor of the bore mapping device as the bore mapping device traverses the wellbore, and thereby generating mapping data corresponding to the surface of the open hole section, as at 204. The method 200 may further include sensing obstructions within the wellbore with an obstruction sensor arranged at a downhole end of the bore mapping device as the bore mapping device traverses the wellbore, as at 206. The method 200 may further include transmitting the mapping data to a data acquisition system in communication with the bore mapping device, as at 208. The method 200 may further include processing the mapping data with the data acquisition system and thereby creating a three-dimensional model of the open hole section of the wellbore, as at 210.

The bore mapping device 118 combines the advantages of both semiconductor laser and laser range finder technologies, providing a more comprehensive solution for measuring distances, detecting obstructions, and visualizing the wellbore environment. In particular, the bore mapping device 118 exhibits the following advantages:

Improved Accuracy: The bore mapping device's laser-based measurement system provides real-time, accurate measurements of the inner diameter of pipes or holes, reducing the potential for errors and improving the accuracy of the measurements.

Enhanced Safety: The bore mapping device 118 has the ability to detect any wellbore geometry anomaly which allows operators to take appropriate precautions to avoid potential obstructions in the bore.

Reduced Downtime: The bore mapping device's non-contact measurement method reduces the risk of damage or mechanical failure compared to traditional mechanical calipers, resulting in less downtime and increased productivity.

Real-Time Data: The bore mapping device's ability to transmit data in real-time enables operators to make more informed decisions quickly, leading to improved operational efficiency and potentially reducing the time and cost associated with mechanical caliper and/or laser logging operations.

Improved Reliability: The bore mapping device's non-contact measurement method eliminates the need for extending arms, reducing the potential for debris accumulation and resulting in more reliable and consistent measurements.

Embodiments disclosed herein include:

A. A well system that includes a surface installation provided at a well surface location, a wellbore extending from the surface installation and providing an open hole section, a bore mapping device conveyable into the wellbore on a conveyance and including a bore surface mapping sensor operable to sense a surface of the open hole section as the bore mapping device traverses the wellbore, and an obstruction sensor arranged at a downhole end of the bore mapping device and operable to sense obstructions within the wellbore. A data acquisition system is in communication with the bore mapping device to receive data generated by the bore surface mapping sensor and the obstruction sensor and operable to create a three-dimensional model of the open hole section of the wellbore.

B. A method for mapping a wellbore includes conveying a bore mapping device into a wellbore extending from a surface installation, the wellbore providing an open hole section, sensing a surface of the open hole section with a bore surface mapping sensor of the bore mapping device as the bore mapping device traverses the wellbore, and thereby generating mapping data corresponding to the surface of the open hole section, sensing obstructions within the wellbore with an obstruction sensor arranged at a downhole end of the bore mapping device as the bore mapping device traverses the wellbore, transmitting the mapping data to a data acquisition system in communication with the bore mapping device, and processing the mapping data with the data acquisition system and thereby creating a three-dimensional model of the open hole section of the wellbore.

C. A bore mapping device includes a bore surface mapping sensor operable to sense a surface of an open hole section of a wellbore as the bore mapping device traverses the wellbore, an obstruction sensor arranged downhole from the bore surface mapping sensor to sense obstructions within the wellbore, and a data acquisition system in communication with the bore mapping device to receive data generated by the bore surface mapping sensor and the obstruction sensor and operable to create a three-dimensional model of the open hole section of the wellbore.

Each of embodiments A, B, and C may have one or more of the following additional elements in any combination: Element 1: wherein the conveyance is selected from the group consisting of wireline, electric line, slickline, wired slickline, coiled tubing, wired coiled tubing, drill pipe, wired drill pipe, and any combination thereof. Element 2: wherein the bore surface mapping sensor comprises a sensor selected from the group consisting of a light detection and ranging (LiDAR) sensor, an ultrasonic sensor, a radar (Radio Detection and Ranging) sensor, an infrared sensor, a laser range finder, a structured light sensor, a dye laser, an excimer laser, a gas laser, and any combination thereof. Element 3: wherein the bore surface mapping sensor comprises a LiDAR sensor including an emitter for emitting light towards the surface of the open hole section, the emitter comprising a laser selected from the group consisting of a laser diode, a fiber laser, a solid-state laser, a microchip laser, a quantum cascade laser, a vertical-cavity laser, a surface-emitting laser, a supercontinuum laser, a semiconductor laser, and any combination thereof. Element 4: wherein the bore surface mapping sensor comprises a detector for detecting light reflected off the surface of the open hole section. Element 5: wherein the detector comprises a photodiode selected from the group consisting of a semiconductor photodiode, a silicon photodiode, a silicon photomultiplier, an avalanche photodiode, and any combination thereof. Element 6: wherein the bore mapping device further includes a displacement mechanism operable to displace an emitter or a detector of the bore surface mapping sensor and thereby increasing an area over which measurements are captured. Element 7: wherein the obstruction sensor comprises a sensor selected from the group consisting of a LiDAR sensor, an ultrasonic sensor, a radar (Radio Detection and Ranging) sensor, an infrared sensor, a laser range finder, a structured light sensor, and any combination thereof. Element 8: wherein the data acquisition system is operable to interpret point cloud data to construct the three-dimensional model of the surface of the open hole section. Element 9: wherein bore mapping device further includes one or more sensors operable to obtain measurements of downhole conditions within the wellbore.

Element 10: further comprising displaying the three-dimensional model of the open hole section of the wellbore to an operator in real-time as the bore mapping device traverses the wellbore. Element 11: wherein the bore surface mapping sensor comprises a LiDAR sensor including an emitter, and wherein sensing the surface of the open hole section comprises emitting light towards the surface of the open hole section with the LiDAR sensor, and detecting light reflected off the surface of the open hole section with a detector forming part of the bore surface mapping sensor.

Element 12: wherein the bore surface mapping sensor comprises a LiDAR sensor including an emitter for emitting light towards the surface of the open hole section, the emitter comprising a laser selected from the group consisting of a laser diode, a fiber laser, a solid-state laser, a microchip laser, a quantum cascade laser, a vertical-cavity laser, a surface-emitting laser, a supercontinuum laser, a semiconductor laser, and any combination thereof. Element 13: wherein the emitter comprises a semiconductor laser diode. Element 14: wherein the bore surface mapping sensor comprises a detector for detecting light reflected off the surface of the open hole section. Element 15: wherein the detector comprises a photodiode selected from the group consisting of a semiconductor photodiode, a silicon photodiode, a silicon photomultiplier, an avalanche photodiode, and any combination thereof. Element 16: further comprising a displacement mechanism operable to displace an emitter or a detector of the bore surface mapping sensor and thereby increasing an area over which measurements are captured. Element 17: wherein the obstruction sensor comprises a sensor selected from the group consisting of a LiDAR sensor, an ultrasonic sensor, a radar (Radio Detection and Ranging) sensor, an infrared sensor, a laser range finder, a structured light sensor, and any combination thereof.

By way of non-limiting example, exemplary combinations applicable to A, B, and C include: Element 4 with Element 5; Element 12 with Element 13; and Element 14 with Element 15.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “comprising,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The use of directional terms such as above, below, upper, lower, upward, downward, left, right, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well.

The invention claimed is:

1. A well system, comprising:
a surface installation provided at a well surface location;
a wellbore extending from the surface installation and providing an open hole section;
a bore mapping device conveyable into the wellbore on a conveyance and including:
a bore surface mapping sensor operable to sense a surface of the open hole section as the bore mapping device traverses the wellbore; and
an obstruction sensor arranged at a downhole end of the bore mapping device and operable to sense obstructions within the wellbore; and
a data acquisition system in communication with the bore mapping device to receive data generated by the bore surface mapping sensor and the obstruction sensor and operable to create a three-dimensional model of the open hole section of the wellbore.

2. The well system of claim 1, wherein the conveyance is selected from the group consisting of wireline, electric line, slickline, wired slickline, coiled tubing, wired coiled tubing, drill pipe, wired drill pipe, and any combination thereof.

3. The well system of claim 1, wherein the bore surface mapping sensor comprises a sensor selected from the group consisting of a light detection and ranging (LiDAR) sensor, an ultrasonic sensor, a radar (Radio Detection and Ranging) sensor, an infrared sensor, a laser range finder, a structured light sensor, a dye laser, an excimer laser, a gas laser, and any combination thereof.

4. The well system of claim 1, wherein the bore surface mapping sensor comprises a LiDAR sensor including an emitter for emitting light towards the surface of the open hole section, the emitter comprising a laser selected from the group consisting of a laser diode, a fiber laser, a solid-state laser, a microchip laser, a quantum cascade laser, a vertical-cavity laser, a surface-emitting laser, a supercontinuum laser, a semiconductor laser, and any combination thereof.

5. The well system of claim 1, wherein the bore surface mapping sensor comprises a detector for detecting light reflected off the surface of the open hole section.

6. The well system of claim 5, wherein the detector comprises a photodiode selected from the group consisting of a semiconductor photodiode, a silicon photodiode, a silicon photomultiplier, an avalanche photodiode, and any combination thereof.

7. The well system of claim 1, wherein the bore mapping device further includes a displacement mechanism operable to displace an emitter or a detector of the bore surface mapping sensor and thereby increasing an area over which measurements are captured.

8. The well system of claim 1, wherein the obstruction sensor comprises a sensor selected from the group consisting of a LiDAR sensor, an ultrasonic sensor, a radar (Radio Detection and Ranging) sensor, an infrared sensor, a laser range finder, a structured light sensor, and any combination thereof.

9. The well system of claim 1, wherein the data acquisition system is operable to interpret point cloud data to construct the three-dimensional model of the surface of the open hole section.

10. The well system of claim 1, wherein bore mapping device further includes one or more sensors operable to obtain measurements of downhole conditions within the wellbore.

11. A method for mapping a wellbore, comprising:
conveying a bore mapping device into a wellbore extending from a surface installation, the wellbore providing an open hole section;
sensing a surface of the open hole section with a bore surface mapping sensor of the bore mapping device as the bore mapping device traverses the wellbore, and thereby generating mapping data corresponding to the surface of the open hole section;
sensing obstructions within the wellbore with an obstruction sensor arranged at a downhole end of the bore mapping device as the bore mapping device traverses the wellbore;
transmitting the mapping data to a data acquisition system in communication with the bore mapping device; and
processing the mapping data with the data acquisition system and thereby creating a three-dimensional model of the open hole section of the wellbore.

12. The method of claim 11, further comprising displaying the three-dimensional model of the open hole section of the wellbore to an operator in real-time as the bore mapping device traverses the wellbore.

13. The method of claim 11, wherein the bore surface mapping sensor comprises a LiDAR sensor including an emitter, and wherein sensing the surface of the open hole section comprises:
emitting light towards the surface of the open hole section with the LiDAR sensor; and
detecting light reflected off the surface of the open hole section with a detector forming part of the bore surface mapping sensor.

14. A bore mapping device, comprising:
a bore surface mapping sensor operable to sense a surface of an open hole section of a wellbore as the bore mapping device traverses the wellbore;
an obstruction sensor arranged downhole from the bore surface mapping sensor to sense obstructions within the wellbore; and
a data acquisition system in communication with the bore mapping device to receive data generated by the bore surface mapping sensor and the obstruction sensor and operable to create a three-dimensional model of the open hole section of the wellbore.

15. The bore mapping device of claim 14, wherein the bore surface mapping sensor comprises a LiDAR sensor including an emitter for emitting light towards the surface of the open hole section, the emitter comprising a laser selected from the group consisting of a laser diode, a fiber laser, a solid-state laser, a microchip laser, a quantum cascade laser, a vertical-cavity laser, a surface-emitting laser, a supercontinuum laser, a semiconductor laser, and any combination thereof.

16. The bore mapping device of claim 15, wherein the emitter comprises a semiconductor laser diode.

17. The bore mapping device of claim 14, wherein the bore surface mapping sensor comprises a detector for detecting light reflected off the surface of the open hole section.

18. The bore mapping device of claim 17, wherein the detector comprises a photodiode selected from the group consisting of a semiconductor photodiode, a silicon photodiode, a silicon photomultiplier, an avalanche photodiode, and any combination thereof.

19. The bore mapping device of claim 14, further comprising a displacement mechanism operable to displace an emitter or a detector of the bore surface mapping sensor and thereby increasing an area over which measurements are captured.

20. The bore mapping device of claim 14, wherein the obstruction sensor comprises a sensor selected from the group consisting of a LiDAR sensor, an ultrasonic sensor, a radar (Radio Detection and Ranging) sensor, an infrared sensor, a laser range finder, a structured light sensor, and any combination thereof.
